(19) United States
(12) Patent Application Publication
(10) Pub. No.: US 2023/0137624 A1
(43) Pub. Date: May 4, 2023

(54) SYSTEM AND METHOD FOR LINING A CAN

(71) Applicant: KA Industries LLC, Gilbert, AZ (US)

(72) Inventors: Adam Kluge, Gilbert, AZ (US); Kade Tibbetts, Denver, AZ (US); Daniel Reed, Gilbert, AZ (US); James Reed, Gilbert, AZ (US)

(21) Appl. No.: 17/979,171

(22) Filed: Nov. 2, 2022

Related U.S. Application Data
(60) Provisional application No. 63/274,996, filed on Nov. 3, 2021.

(51) Int. Cl. B65D 33/28; B65F 1/00; B65D 81/26; B31B 70/81

(52) U.S. Cl. CPC B65D 33/28; B31B 70/8134; B65D 81/264; B65F 1/002; B31B 2160/20

(57) ABSTRACT

A liner comprising a first section and a second section being joined along at least three edges and a fourth edge of the first section and the second section defining an opening of the liner. A liner having a drawstring wherein a first channel can be sealed around the drawstring and proximal to the opening of the first section and the second section. An elastic band wherein the second channel can be sealed around the elastic band and substantially below the drawstring and proximal to the opening of the first section and second section. A pad wherein the pad can substantially line at least one edge of the liner. The liner can be sized to fit a standard bedpan, commode, or trashcan. The liner can be generally circular or rectangular. The liner limits the opportunities for potential cross-contamination with surfaces or other people and removes the need to clean the bedpan while still maintaining sanitary conditions.

### CROSS REFERENCE TO RELATED APPLICATIONS

The present application claims the benefit under 35 U.S.C. 119 of U.S. Provisional Pat. Application Ser. No. 63/274,996 filed Nov. 03, 2021. The U.S. Provisional Pat. Application Ser. No. 63/274,996 is hereby incorporated by reference in its entirety

### TECHNICAL FIELD

The present specification relates to bedpan and trash can accessories, more particularly a liner for a bedpan and trashcan.

### BACKGROUND

Bedpans, commodes, and trash cans come in a variety of different shapes and styles and are formed from a variety of different materials. Common to most bedpans is shallow vessel that has a reservoir in its lower portion that can be accessed through an opening in an upper portion which is typically surrounded by a broad rim. The bedpan is significantly wider and longer than it is high to facilitate relatively straightforward passage of the bedpan underneath a supine patient (or other individual), to allow the patient to relieve the patient’s bowels and/or bladder without needing to get out of bed.

The commode is a chair-like apparatus with arm rests with a bedpan inserted into the seat portion. Its purpose is to assist a patient in relieving the patient’s bowels and/or bladder in an upright position, but limiting the movement and travel required by the patient.

Bedpan use is typically taught such that the bedpan is used alone and then the contents typically poured into a toilet and then cleaned for reuse However, staff/caregivers improvise various absorbent materials to hold waste in the bedpan, such as filling the bedpan cavity with toilet tissue or placing multiple layers of various liners (eg., washcloths, sheets, pads) or disposable sheets or pads under the bedpan in attempts to avoid or contain the inevitable spills. The emptying and cleaning process for the bedpan also provides several opportunities for potential cross-contamination of body fluids with surfaces and other persons.

Accordingly, there exists a need for a bedpan liner which is easily used with a bedpan and can limit the opportunities for potential cross-contamination of body fluids with surfaces or other people.

### SUMMARY

Aspects disclosed herein comprise a liner for a bedpan, commode, trash can and/or the like. A liner can comprise a first section and a second section being joined along at least three edges and a fourth edge of the first section and the second section defining an opening of the liner. A first channel and a second channel wherein the first channel can be formed substantially near the opening and the second channel is formed substantially below the first channel of the first section and the second section. A drawstring wherein the first channel can be sealed around the drawstring and proximal to the opening of the first section and the second section. An elastic band wherein the second channel can be sealed around the elastic band and substantially below the drawstring and proximal to the opening of the first section and second section. The channel at least partially enclosing the drawstring creating at least one access cutout. The elastic band completely enclosed in the second channel. A pad wherein the pad can substantially line at least one edge of the liner. The pad can be comprised of absorbent materials such as superabsorbent polymers, polymers, or cotton. The liner can be sized to fit a standard bedpan, commode, or trashcan. The liner can be generally circular or rectangular.

The method of making a liner comprising providing a first section and a section wherein the first section is sonically sealed to the second section on at least three edges creating an opening on a fourth edge. Placing a drawstring substantially near the fourth edge along a inner perimeter of the first section and the second section. Placing a elastic band substantially below the drawstring along the inner perimeter of the first section and the second section. Folding over the fourth edge into the inside of the first section and the second section proximal to the open end wherein the folded material is sonically welded around the perimeter of the first section and the second section in at least two locations creating a first channel and a second channel around the drawstring and the elastic band. The first channel can comprise at least one opening to allow access to the drawstring.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor’s intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of ..., without also reciting in such phrases any structure, material or act in support of the function. Thus, even when the claims recite a “means for performing the function of ..., step for performing the function of ...,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of one embodiment of a liner in accordance to one, or more embodiments;

FIG. 2 is a front view of one embodiment of an expanded liner in accordance to one, or more embodiments;

FIG. 3 is a side view of one embodiment of a liner in accordance to one, or more embodiments;

FIG. 4a is a front view of an example embodiment of a liner in accordance to one, or more embodiments;

FIG. 4b is a side view of an example embodiment of a liner in accordance to one, or more embodiments;

FIG. 5 is another embodiment of a liner in accordance to one, or more embodiments;

FIG. 6 is another embodiment of a liner in accordance to one, or more embodiments; and

FIG. 7 is yet another embodiment of a liner in accordance to one, or more embodiments.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

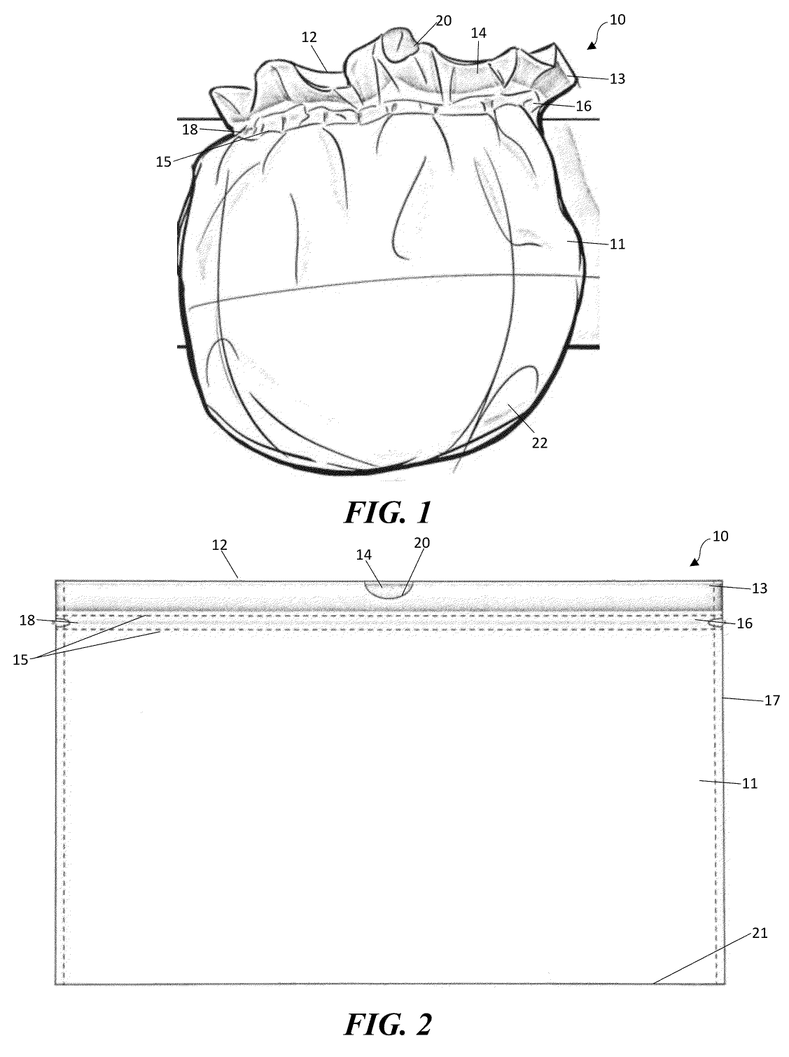

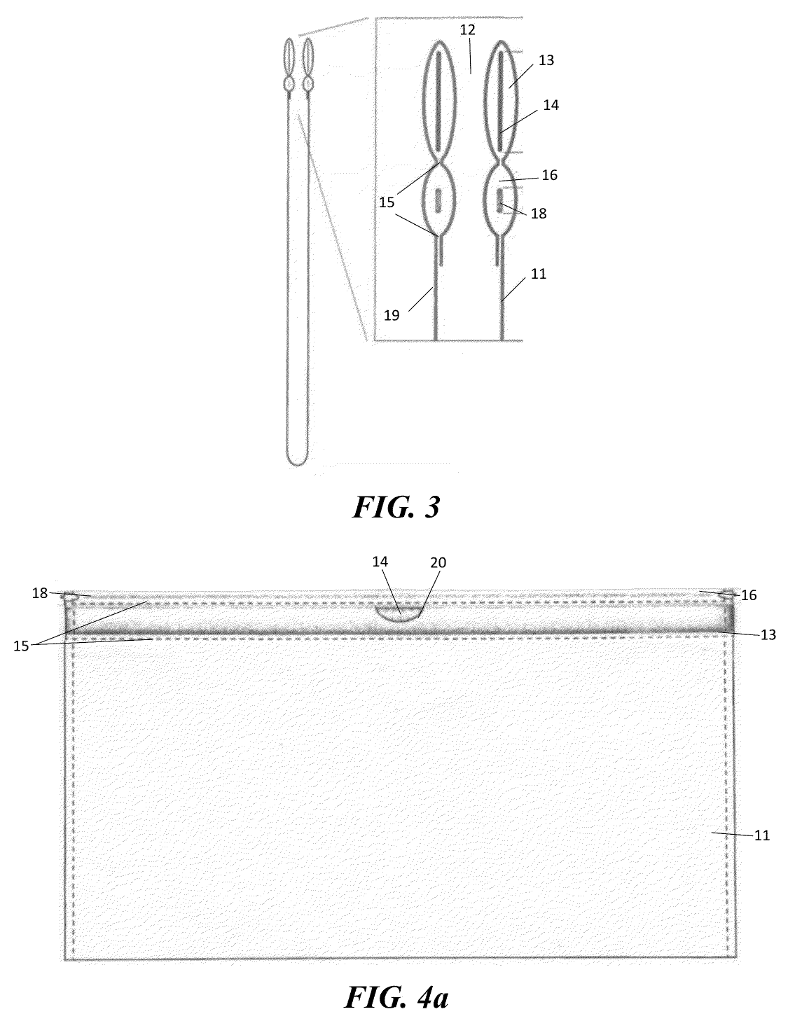

Referring initially to FIGS. 1 - 3 a liner is shown generally at 10. The liner 10 can comprise a first section 11 and a second section 19 being joined along at least two edges 17 forming an inner chamber. A fourth edge 21 of the first section 11 and the second section 19 can define an opening 12 of the liner wherein the opening can give the user access to the inside of the first section and the second section The liner 10 can be any shape such as, for example, spherical, cylindrical, rectangular, trapezoidal, or the like. The liner 10 can be made from any water nonpermeable material, such as, for example, plastic, latex, nylon, silk, and/or the like. In certain embodiments, the liner 10 can be one section folded over on itself and joined on at least two edges, or it can be two sections joined at least three edges, or it can be three sections joined at four edges, or the like. The liner 10 can be any shape, such as, for example, rectangular, spherical, trapezoidal, cylindrical, and the like.

A drawstring 14 can be coupled proximal to the opening 12 of the first section 11 and the second section 19. The liner 10 can further comprise a first channel 13 and a second channel 16 wherein the first channel is formed substantially near the opening and the second channel is formed substantially below the first channel wherein the perimeter of the liner includes the first channel and the second channel. The liner 10 can comprise a drawstring 14 and an elastic band wherein the drawstring can be sealed within the first channel. The elastic band 18 can be sealed within the second channel 16 wherein the elastic band and second channel can be substantially below the drawstring and proximal to the opening of the first section 11 and the second section 19.

The first channel 13 can be sealed by any means such as, for example, glue, stitches, snaps, sonically welded, or the like to the first section 11 and the second section 19. The drawstring 14 can be at least partially enclosed in the first channel 13. The first channel 13 can have at least one access cutout 20 to allow the user to easily access the drawstring. The drawstring 14 can be comprised of plastic, cotton, jute, polyester, or the like. The drawstring 14 can be the same plastic as the bag, or it can be a thicker or a thinner plastic. The first channel 13 can allow the drawstring to freely float within the channel or the drawstring can be secured within the first channel at least one location within the first channel. In certain embodiments, the drawstring 14 can be multiple pieces such that where the first section 11 and the second section 19 are sealed the drawstring can be joined or sealed making one complete piece. In other embodiments the drawstring can be omitted.

An elastic band 18 can be sealed within the second channel 16 wherein the second channel and elastic band can be substantially below the drawstring 14 and proximal to the opening of the first section 11 and second section 19. The second channel 16 can form the channel for the elastic band any attaching means, such as, for example, glue, stitches, snaps, sonically welded, or the like. The elastic band 18 can be comprised of any flexible and/or stretchable material, such as, for example, rubber, synthetic rubber, spandex, latex, EPDM, polyester, cotton, nylon, polyurethane, or the like. The elastic band 18 can be at least partially enclosed in a second channel 16 and in the preferred embodiment the elastic band is fully enclosed within the second channel. The first channel 13 and the second channel 16 can be defined by a seam 15 or the like. The seam can be created by any means of attaching multiple layers, such as, for example, stitching, welding, adhering, and/or the like. The elastic band 18 can be in one or more pieces wherein the pieces can be joined to form a complete elastic band. In certain embodiments the elastic band 18 can be omitted. In other embodiments the first channel 13 can be below the second channel 16 wherein the elastic band 18 and second channel are located substantially closer to the opening 12 than the drawstring 14 and the first channel 13.

The liner 10 can be sized to fit a standard bedpan, commode or trashcan wherein the elastic band can keep the upper portion of the liner 10 tight around the outer circumference of the bedpan, commode or trashcan without allowing for spillage of the contents. In certain embodiments the liner 10 can be sized to fit any size container, allowing for the user to easily secure the liner in place and then close the liner with the contents inside to avoid spillage.

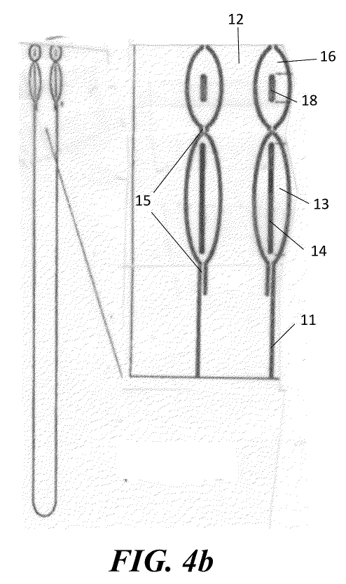

Referring to FIG. 4 the liner 10 can have the drawstring 14 at the outer edge of the bag 11 and proximal to the open end 12 with the elastic band 18 adjacent, or the elastic band 18 can be at the outer edge and proximal to the open end 12 with the drawstring 14 adjacent.

In at least one embodiment the liner 10 also comprises a pad 22 which may be comprised of absorbent materials, such as, for example, superabsorbent polymers, polymers, cotton, paper, wood pulp, foam, or the like. The pad 22 can be coupled to the bag, integral with the liner 10, or it can be separate and placed within the liner. The pad 22 can at least partially cover the interior of the liner 10. The pad 22 can be held in place by any securing means, such as, for example, high friction materials, adhesive, snaps, magnets, hook and loop, and the like. The adhesive backing can have a removable protective strip.

In at least one embodiment the elastic band 18 can also be the drawstring 14, or the drawstring can be the elastic band. In this embodiment the liner 10 can have a channel to at least partially enclose the elastic band. The first channel 13 or the second channel 16 can have an access cutout 20 in the channel such that a portion of the elastic band 18 is easily accessible and can be pulled through the notch 20 to cinch the open end 12, thus functioning as the drawstring.

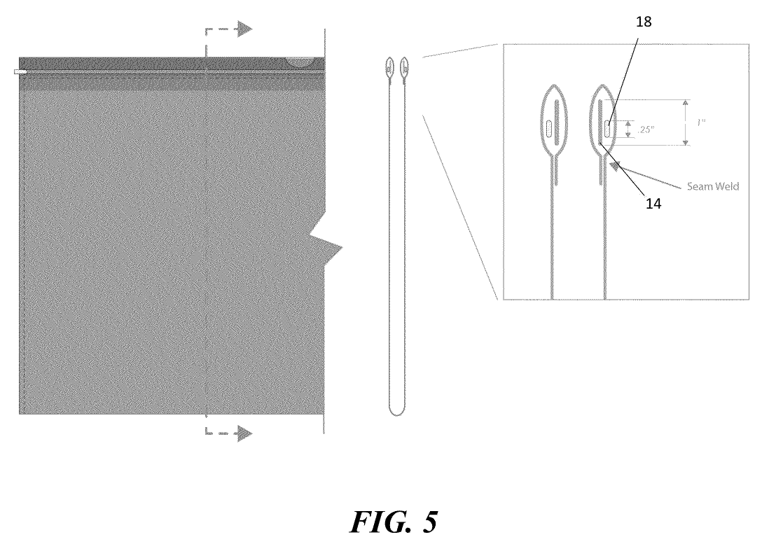

Referring to FIG. 5, which shows another embodiment of a liner wherein the drawstring 14 and the elastic band 18 are both sealed within the first channel 13, and the second channel is omitted.

The liner 10 can be placed over the bedpan, commode, trash can, or the like in such a manner that the bag is at least partially within the bedpan, commode, trash can, or the like. The liner 10 can be folded over the top edge so that the drawstring 14 and/or the elastic band 18 is proximal to the side of the bedpan exterior and/or under the bedpan. The elastic band 18 can clinch the liner 10 around the bedpan which helps keep the liner in position. The liner 10 protects the bedpan, commode, trash can, or the like from contamination from body fluids or other waste. When finished, the liner 10 is removed by unfolding the bag over the top edge so that all fluids or other waste is contained within the liner. The drawstring 14 is then pulled to cinch the top of the bag, keeping the body fluids and/or other waste inside the liner for effect waste containment and easy disposal which limits the opportunities for potential cross-contamination with surfaces or other people. Also removing the need to clean the bedpan while still maintaining sanitary conditions.

The method of making a liner 10 comprising providing a first section 11 and a second section 19 wherein the first section is sonically sealed to the second section on at least three edges 17 creating an opening 12 on a fourth edge. Placing a drawstring 14 substantially near the fourth edge along an inner perimeter of the first section 11 and the second section 19. Placing an elastic band 18 substantially below the drawstring 14 along the inner perimeter of the first section 11 and the second section 19. Folding over the fourth edge into the inside of the first section 11 and the second section 19 proximal to the open end wherein the folded material is sonically welded around the perimeter of the first section and the second section in at least two locations creating a first channel and a second channel around the drawstring and the elastic band. The first channel 13 can comprise at least one opening to allow access to the drawstring 14.

Another method of making a liner 10 comprising providing a first section 11 and a second section 19 wherein the first section is sonically sealed to the second section on at least three edges 17 creating an opening 12 on a fourth edge. Placing an elastic band 18 substantially near the fourth edge along an inner perimeter of the first section 11 and the second section 19. Placing a drawstring 14 substantially below the elastic band 18 along the inner perimeter of the first section 11 and the second section 19. Folding over the fourth edge into the inside of the first section 11 and the second section 19 proximal to the open end wherein the folded material is sonically welded around the perimeter of the first section and the second section in at least two locations creating a first channel and a second channel around the drawstring and the elastic band. The first channel 13 can comprise at least one opening to allow access to the drawstring 14.

The method of making a liner 10 comprising providing a first section 11 and a second section 19 wherein the first section is sonically sealed to the second section on at least three edges 17 creating an opening 12 on a fourth edge. Placing a drawstring 14 and an elastic band 18 substantially near the fourth edge along an inner perimeter of the first section 11 and the second section 19. Folding over the fourth edge into the inside of the first section 11 and the second section 19 proximal to the open end wherein the folded material is sonically welded around the perimeter of the first section and the second section in at least one location creating a first channel around the drawstring and the elastic band. The first channel 13 can comprise at least one opening to allow access to the drawstring 14.

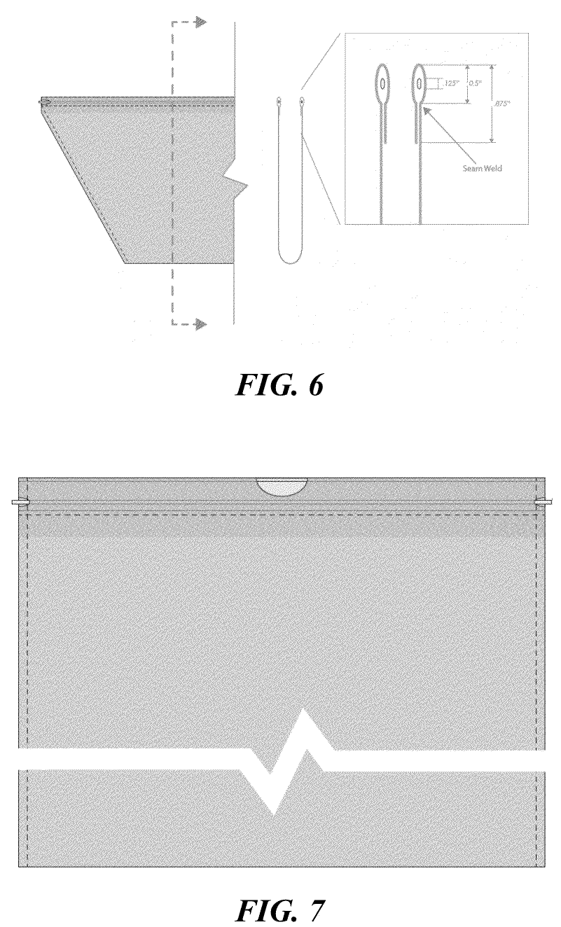

Referring to FIG. 6 and FIG. 7 showing other embodiments of a liner.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

1. A liner comprising a first section and a second section being joined along at least three edges;
a fourth edge of the first section and the second section defining an opening of the liner;
a first channel and a second channel wherein the first channel is formed substantially near the opening and the second channel is formed substantially below the first channel of the first section and the second section;
a drawstring wherein the first channel is sealed around the drawstring and proximal to the opening of the first section and the second section; and
an elastic band wherein the second channel is sealed around the elastic band and substantially below the drawstring and proximal to the opening of the first section and second section.

2. The liner of claim 1 wherein the channel at least partially enclosing the drawstring creating at least one access cutout.

3. The liner of claim 1 wherein the elastic band completely enclosed in the second channel.

4. The liner of claim 1 further comprising a pad wherein the pad can substantially line at least one edge of the liner.

5. The liner of claim 4 wherein the pad is comprised of absorbent materials such as superabsorbent polymers, polymers, or cotton.

6. The liner of claim 1 wherein the liner is sized to fit a standard bedpan, commode, or trashcan.

7. The liner of claim 1 wherein the liner is generally circular or rectangular.

8. The method of making a liner comprising:
providing a first section and a second section wherein the first section is sonically sealed to the second section on at least three edges creating an opening on a fourth edge;
placing a drawstring substantially near the fourth edge along a inner perimeter of the first section and the second section;
placing a elastic band substantially below the drawstring along the inner perimeter of the first section and the second section;
folding over the fourth edge into the inside of the first section and the second section proximal to the open end wherein the folded material is sonically welded around the perimeter of the first section and the second section in at least two locations creating a first channel and a second channel around the drawstring and the elastic band.

9. The method of making a liner of claim 8 wherein the first channel comprises at least one opening to allow access to the drawstring.

10. The method of making a liner of claim 8 wherein the first section and the second section are one complete section forming a bottom portion and sealed on at least two sides.
